(19) United States
(12) Patent Application Publication
(10) Pub. No.: US 2023/0226620 A1
(43) Pub. Date: Jul. 20, 2023

(54) Drill and method for producing a drill

(71) Applicant: KENNAMETAL INC., Latrobe, PA (US)

(72) Inventor: Herbert Rudolf KAUPER, Fuerth (DE)

(21) Appl. No.: 18/098,445

(22) Filed: Jan. 18, 2023

(30) Foreign Application Priority Data
Jan. 19, 2022 (DE) 102022101190.9

(51) Int. Cl. B23B 51/02

(52) U.S. Cl. CPC B23B 51/02; B23B 2251/406; B23B 2251/14

(57) ABSTRACT

A drill has at least one main cutting edge (22) and a helical flute (20) abutting the main cutting edge (22). The surface of the flute (20) has a spiral segment (28) and an edge segment (30) abutting the main cutting edge (22). The roughness of the edge segment (30) is less than the roughness of the spiral segment (28). Furthermore, a method for producing a drill is provided.

### RELATED APPLICATION DATA

The present application claims priority pursuant to 35 U.S.C. § 119(a) to German Patent Application Number 102022101190.9 6filed Jan. 19, 2022, which is incorporated herein by reference in its entirety.

### FIELD

The invention relates to a drill having at least one main cutting edge and a helical flute abutting the main cutting edge. Furthermore, the invention relates to a method for producing such a drill.

### BACKGROUND

Drills with helical flutes such as spiral drills are known.

In order to keep drilling costs within reasonable bounds, a compromise is typically made in drills with respect to cutting quality, tool life, and production costs.

The problem addressed by the invention is to provide a drill as well as a method for producing such a drill that has a particularly good cutting quality and can also be inexpensively produced.

### SUMMARY

The problem is solved by a drill having at least one main cutting edge and a helical flute abutting the main cutting edge. The surface of the flute has a spiral segment and an edge segment abutting the main cutting edge. The roughness of the edge segment is less than the roughness of the spiral segment.

According to the present invention, it has been found that it is sufficient to design only the edge segment, instead of the entire flute, to be particularly smooth in order to significantly lower the frictional coefficient during machining. In this way, less heat is produced during drilling, whereby particularly high-quality drill holes can be made, even in temperature-sensitive materials. Further, the wear of the drill is thereby reduced and thus its tool life is increased. Furthermore, the cutting speed can be increased compared to a drill without an edge segment designed according to the present invention.

The drill is in particular a spiral drill or a replaceable cutting head that forms a spiral drill together with a tool shaft.

Further, the edge segment at least partially forms a rake face of the main cutting edge.

In one embodiment the roughness of the edge segment is less than 0.3 Ra, in particular less than 0.1 Ra. Ra stands for the midpoint roughness coefficient. In this way, the edge segment is particularly smooth and thus the frictional coefficient between the edge segment and the chip cut away by means of the main cutting edge is particularly low.

Additionally or alternatively, the roughness of the spiral segment can be at least 0.3 Ra, because this coefficient is sufficient to quickly and reliably remove the separated chips via the flute. Thus, the drill can be produced inexpensively.

In a further embodiment, at least 25%, preferably at least 50%, and in particular at least 75% of the main cutting edge abuts the edge segment. As a result, a particularly large proportion of the flute abutting the main cutting edge is formed as a smooth edge segment, so that the chips formed during drilling slide over the rake face with low friction.

Further, it can be provided that the edge segment does not extend to a tip of the drill. The cutting speeds are low due to the low radial distance to the rotational axis of the drill near the tip, so that a particularly low roughness is not required in this area in order to ensure a high cutting quality. Thus, the portion of the flute abutting the tip can have a higher roughness than the edge segment, thereby keeping the production costs of the drill low.

Additionally, or alternatively, the edge segment can radially outwardly abut a side cutting edge or guiding edge of the drill, such that the portion of the flute which has a large radial distance to the rotational axis of the drill, and thus high cutting speeds, is particularly smooth.

According to one embodiment, the edge segment extends over an axial length that is at least 50%, preferably at least 75%, in particular at least 100% of the diameter or nominal diameter of the drill. The edge segment thereby ensures a fast and low-friction removal of the chips.

According to a further embodiment, the edge segment extends over an axial length that is at most 200%, preferably at most 150%, in particular at most 100% of the diameter or nominal diameter of the drill. In this way, the edge segment is limited to a portion near the main edge in which the low roughness is particularly effective. This has the advantage that the edge segment can be small and the spiral segment can be relatively large, whereby the drill can be produced with little effort.

Furthermore, it can be provided that the edge segment has a smaller spiral angle than the spiral segment, in particular wherein the spiral angle of the edge segment is smaller by at least 1° than the spiral angle of the spiral segment. The edge segment can thus be produced by a chipping process such as grinding and thus inexpensively.

According to the invention, a method for producing a drill, in particular a drill according to the invention, with at least one main cutting edge and a helical flute abutting the main cutting edge is also provided in order to solve the aforementioned problem. The method comprises the following steps:
a) grinding the flute, and
b) subsequent fine-grinding of an edge segment abutting the main cutting edge of the surface of the flute.

In the sense of the invention, fine-grinding is understood to mean a grinding operation by means of which a surface with a lower roughness is produced than during the grinding operation by means of which the flute was produced in the preceding step. Thus, the edge segment has a lower roughness than the remaining surface of the flute. This has the advantages previously mentioned in connection with the drill according to the invention. By first forming the flute without the edge segment by means of grinding and only subsequently forming the edge segment by means of the more complex fine-grinding, the production process is furthermore particularly efficient.

### BRIEF DESCRIPTION OF THE DRAWINGS

Further advantages and features will emerge from the following description and from the accompanying drawings. The figures show:

FIG. 1 a drill according to the invention in a side view,

FIG. 2 the cutting head of the drill from FIG. 1 in a detail view,

FIG. 3 the cutting head of the drill from FIG. 1 in a schematic view,

FIG. 4 a drill according to the invention according to a further embodiment in a side view,

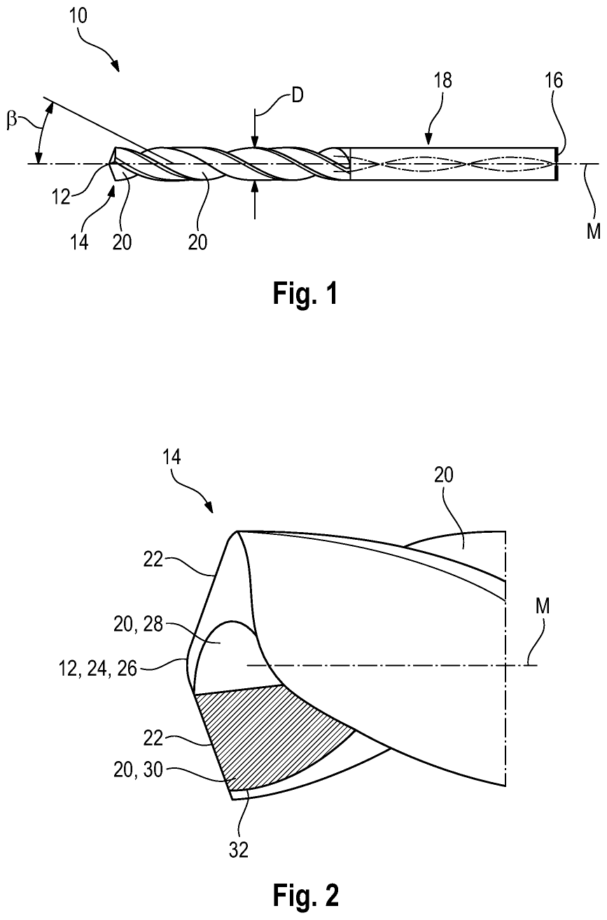

In FIG. 1, a drill 10 having a nominal diameter D is shown.

The drill 10 extends along a longitudinal central axis M and has a cutting head 14 at an axial end 12 and a shaft 18 at the opposite axial end 16, by means of which the drill 10 can be mounted in a tool holder.

In the present embodiment, the drill 10 is a spiral drill with two helical flutes 20, each extending from the axial end 12 to the shaft 18.

Accordingly, the cutting head 14 comprises two main cutting edges 22 (see FIG. 2), each abutting one of the two flutes 20.

The main cutting edges 22 are connected to one another via a transverse cutting edge 24, which forms a tip 26 of the drill 10.

In an alternative embodiment, the drill 10 can be any drill having at least one helical flute 20 abutting a main cutting edge 22 of the drill 10.

The cutting head 14 is formed from a carbide.

Furthermore, the cutting head 14 does not have a coating, i.e., the cutting head 14 is formed in a non-coated manner.

Generally, the cutting head 14 can be formed from any material.

Additionally or alternatively, the cutting head 14 can comprise a coating, i.e., it is coated at least in sections.

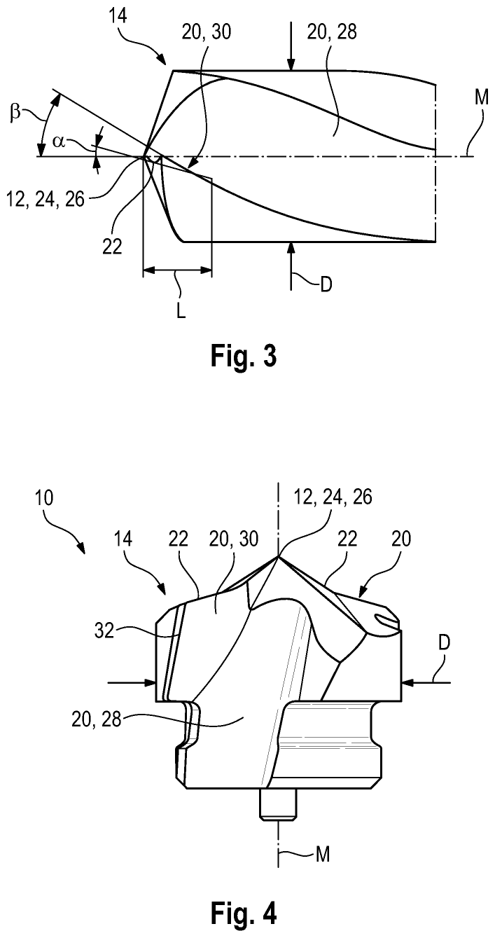

Based on FIGS. 2 and 3, the design of one of the helical flutes 20 is explained below as an example for all of the flutes 20.

The surface of the helical flute 20 has a spiral segment 28 and an edge segment 30.

In the present exemplary embodiment, the surface area of the helical flute 20 consists of the spiral segment 28 and the edge segment 30. That is to say, the surface of the flute 20 that does not form the edge segment 30 forms the spiral segment 28.

In an alternative embodiment, the surface of the helical flute 20 can comprise one or more further segments.

Preferably, the surface area of the spiral segment 28 is greater than the surface area of the edge segment 30.

The edge segment 30 extends inwardly from a radially outwardly arranged guide edge 32 of the cutting head 14 over about 80% of the abutting main cutting edge 22 and thus not to the tip 26.

In this way, the edge segment 30 forms a substantial part of the rake face associated with the main cutting edge 22.

In principle, any portion of the main cutting edge 22 can abut the edge segment 30, but preferably the portion is at least 25%, further preferably at least 50%, in particular at least 75%.

Further, in an alternative embodiment, the guide edge 32 can be a side cutting edge of the cutting head 14.

Additionally or alternatively, the edge segment 30 can be spaced apart from guide edge 32 and/or can extend to the tip 26.

In the axial direction, the edge segment 30 has an axial length L (see FIG. 3) which corresponds to about 90% of the nominal diameter D of the drill 10.

In an alternative embodiment, the axial length L of the edge segment 30 is at least 50%, preferably at least 75%, in particular at least 100% of the nominal diameter D.

Additionally or alternatively, the axial length L of the edge segment 30 can be at most 200%, preferably at most 150%, in particular at most 100% of the nominal diameter D.

In this context, the edge segment 30 has a spiral angle α of 28°, while the spiral angle β of the spiral segment 28 is 30° here.

In an alternative embodiment, the spiral angle α and the spiral angle β can each be any size.

However, the spiral angle α is preferably smaller than the spiral angle β, in particular by at least 1°.

The edge segment 30 has a roughness of 0.05 Ra, while the spiral segment 28 has a roughness of 0.3 Ra.

Generally, the edge segment 30 and the spiral segment 28 can have any roughness, however, in all embodiments, the roughness of the spiral segment 28 is greater than the roughness of the edge segment 30.

In an alternative embodiment, the roughness of the edge segment 30 is less than 0.3 Ra, in particular less than 0.1 Ra.

Additionally or alternatively, the roughness of the spiral segment 28 can be at least 0.3 Ra.

In an alternative embodiment, the drill is a replaceable cutting head 10 (see FIG. 4), which forms a spiral drill together with a tool shaft. For the components known from the above embodiment, the same reference numerals are used, and reference is made in this respect to the foregoing explanations.

To produce the drill 10, the following method is provided.

In a first step, the helical flutes 20 are ground in the form of raw flutes into a blank of the drill 10.

The raw flutes here have the spiral angle β and the roughness of the spiral segments 28 of the helical flutes 20.

In a subsequent second step, the edge segments 30 are formed by fine-grinding the raw flutes respectively in a corresponding area abutting the main cutting edge 22 of the associated flute 20.

As a result, the edge segments 30 receive the spiral angle α and the lower roughness compared to the spiral segments 28.

The grinding as well as the fine-grinding can be done by means of grinding discs or grinding rollers.

The grinding discs or grinding rollers for the fine-grinding have a smaller grain size than the grinding discs or grinding rollers for the grinding.

Furthermore, the fine-grinding is performed at a lower cutting speed than the grinding in the preceding step.

In this way, a drill 10 as well as a method for producing a drill 10 are provided, which can be produced with little effort and has particularly good cutting properties.

The invention is not limited to the embodiments shown. Individual features of one embodiment can in particular be combined as desired with features of other embodiments, in particular independently of the other features of the corresponding embodiments.

### LIST OF REFERENCE NUMERALS

10 Drill

12 Axial end

14 Cutting head

16 Axial end

18 Shaft

20 Flute

22 Main cutting edge

24 Transverse cutting edge

26 Tip

28 Spiral segment

30 Edge segment

32 Guide edge

L Length

D Diameter

α Spiral angle

β Spiral angle

1. A drill comprising at least one main cutting edge and a helical flute abutting the main cutting edge, wherein the surface of the flute has a spiral segment and an edge segment abutting the main cutting edge, and wherein the roughness of the edge segment is less than the roughness of the spiral segment.

2. The drill according to claim 1, wherein the roughness of the edge segment is less than 0.3 Ra.

3. The drill according to claim 1, wherein the roughness of the edge segment is less than 0.1 Ra.

4. The drill according to claim 1, wherein the roughness of the spiral segment is at least 0.3 Ra.

5. The drill according to claim 1, wherein at least 25% of the main cutting edge abuts the edge segment.

6. The drill according to claim 1, wherein at least 50% of the main cutting edge abuts the edge segment.

7. The drill according to claim 1, wherein at least 75% of the main cutting edge abuts the edge segment.

8. The drill according to claim 1, wherein the edge segment does not extend to a tip of the drill.

9. The drill according to claim 1, wherein the edge segment radially outwardly abuts a side cutting edge or guide edge of the drill.

10. The drill according to claim 1, wherein the edge segment extends over an axial length (L) which is at least 50% of the diameter (D) of the drill.

11. The drill according to claim 1, wherein the edge segment extends over an axial length (L) which is at least 75% of the diameter (D) of the drill.

12. The drill according to claim 1, wherein the edge segment extends over an axial length (L) which is at least 100% of the diameter (D) of the drill.

13. The drill according to claim 1, wherein the edge segment extends over an axial length (L) which is at most 200% of the diameter (D) of the drill.

14. The drill according to claim 1, wherein the edge segment extends over an axial length (L) which is at most 150% of the diameter (D) of the drill.

15. The drill according to claim 1, wherein the edge segment extends over an axial length (L) which is at most 100% of the diameter (D) of the drill.

16. The drill according to claim 1, wherein the edge segment has a smaller spiral angle (α) than the spiral segment.

17. The drill according to claim 16, wherein the spiral angle (α) of the edge segment is smaller by at least 1° than the spiral angle (β) of the spiral segment.

18. A method for producing a drill comprising at least one main cutting edge and a helical flute abutting the main cutting edge, wherein the method comprises the following steps:
a) grinding of the flute, and
b) subsequent fine-grinding of an edge segment abutting the main cutting edge of the surface of the flute.
